(19) United States
(12) Patent Application Publication
(10) Pub. No.: US 2021/0108934 A1
(43) Pub. Date: Apr. 15, 2021

(54) COLLABORATIVE MULTIMODAL TRIP PLANNING

(71) Applicants: Deepak Dasalukunte, Beaverton, OR (US); Ignacio Javier Alvarez Martinez, Portland, OR (US); Richard Dorrance, Hillsboro, OR (US)

(72) Inventors: Deepak Dasalukunte, Beaverton, OR (US); Ignacio Javier Alvarez Martinez, Portland, OR (US); Richard Dorrance, Hillsboro, OR (US)

(21) Appl. No.: 17/131,907

(22) Filed: Dec. 23, 2020

(51) Int. Cl. G01C 21/34

(52) U.S. Cl. CPC G01C 21/3423; G01C 21/3484; G01C 21/3461; G01C 21/3438

(57) ABSTRACT

Various systems and methods for collaborative multimodal trip planning are described herein, including receiving a user request for a multi-user transit plan, determining candidate travel paths for first and second users, identifying a merge opportunity in the candidate travel paths to coordinate shared travel between the first and second users, determining adjusted travel paths for the first and second users using the identified merge opportunity, and determining a cost of the adjusted travel paths with respect to the candidate travel paths.

### TECHNICAL FIELD

Embodiments described herein generally relate to transportation, and in particular, to collaborative multimodal trip planning.

### BACKGROUND

Conventional route planning solutions consider geolocation and traffic conditions in providing users with the fastest or shortest path to a desired location. Multimodal transportation is transportation, movement between and origin and a destination, including different modes of transportation, such as different transportation types or sources, and often, in the context of multimodal transport of people, among multiple operators. With limited interaction between and integration of different transportation options across different transportation operators, users must often plan, pay for, and carry out trips and transfers manually.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIGS. 1 and 2 illustrate an example mobility system and a method of adding travel friends to a user profile to connect users of the mobility application.

FIG. 3 illustrates an example collaborative trip planning method.

FIGS. 4A-4C illustrate example trip planning scenarios.

FIG. 5 illustrates an example processing platform including a trip planning circuit and associated components and subcomponents.

FIG. 6 illustrates an example machine in the form of a computer system, within which a set or sequence of instructions may be executed to cause the machine to perform any one of the methodologies discussed herein.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

The present inventors have recognized, among other things, that a need exists for seamless transfer between and organization of different transportation operators, such as public transportation operators (PTOs). Transportation Network Companies (TNCs) (e.g., Uber, Lyft, Didi, etc.), or other operators or personal modes of transportation, etc. The systems and methods disclosed herein provide an integrated solution to effectively incorporate available modes of transportation for a user, from personal modes of transport (e.g., bicycle, personal vehicle, walking, running, etc.) to transportation operators (e.g., PTOs, TNCs, etc.) to provide the best cost-benefit mode, environmental mode, health-impact mode, etc., for the travel situation or circumstance at hand.

In addition, the systems and methods disclosed herein provide a collective trip planning solution to manage meet-up, plan, and share travel opportunities between several individuals (e.g., family, the same household, friends, etc.) that might be located in different areas at the time of undertaking the trip. Trip suggestions may reflect, among other things, wellbeing scores, carbon footprint, situation-based recommendations (e.g., weather, user situation, user priorities, user preferences, etc.), etc.

Collective trip planning is a scenario where multiple users (e.g., from same family or group of friends) coordinate to determine a travel plan, often including trips that merge at a merge opportunity, such as a common point. Collective trip planning becomes multimodal when multiple transportation operators are considered. The common point is often a destination, but in certain examples, is a point at which the path of multiple users joins, such that the multiple users can continue further to the destination together.

There are many benefits to pre-destination convergence. For example, users of different modes can converge to share a single mode of transport, reducing cost or resource usage, while also increasing the amount of time the users spend together (e.g., a first user has a car, and picks up a second user at a meeting point on the way to an event or destination). Family members and friends often originate travel at different points to converge at a common destination. The present inventors have recognized, among other things, systems and methods that can prioritize travel taken together, instead of only prioritizing the shortest or quickest path, or the cheapest or least environmentally impactful path.

Office commute is another example where group of people meet at a certain point using their own means of multimodal transport and continue their journey to workplace. Intermittent or discontinuous usage is another feature of shared travel, where a user intentionally plans a disruption or stoppage in their trip either to run errands (e.g., grocery shopping) or meet friends or family (e.g., for lunch/coffee) before resuming the trip after the disruption or stoppage. Discontinuous trip planning can occur in conjunction with or independent of collaborative multimodal trip planning, including incorporation of the available modes of transportation of the user.

In an example, a collaborative multimodal trip planning circuit can receive input from at least one user, such as a user request for a multi-user transit plan for a group of users including at least first and second users, and provide collaborative multimodal trip planning for the group of users having the same or different origins, meeting points, waypoints, modes of transport, points of convergence, destinations, etc. The trip planning circuit can coordinate meeting at a destination or waypoint, or merge trips of multiple users, such as to coordinate arrival at the destination or waypoint, in certain examples, sharing what would otherwise have been separate trip segments traveled alone. In other examples, the trip planning circuit can coordinate shared moments among users in daily life, where otherwise unknown “near misses” may have occurred.

For example, if a first user agrees to meet a second user at a restaurant, and the trips for both users involve a bus or train, the first and second users can provide access to the trip planning circuit to receive location information of both users and provide instructions to travel to the restaurant at or near the same time. Traditionally, a navigation circuit would compute, for each of the first and second users, travel paths for the first and second users from their current or starting location to the restaurant as the fastest travel path. In this example, however, if the first user is on a first bus to the restaurant, the trip planning circuit can provide instruction to the second user to let a particular bus pass, or to walk an additional segment to board the first bus of which the first user is a passenger. Such instruction to let a specific bus pass is an example of identifying a merge opportunity in the candidate travel path and determining an adjusted travel path.

Instead of traveling to the restaurant alone via the shortest or fastest route and waiting alone for the first user to arrive, the trip planning circuit can instruct the second user to spend a portion of that waiting time at the outset to merge travel with the first user, increasing the time spent together between different the users, and reducing the otherwise-alone wait time at the at the restaurant. Users would no longer need to text or call people for updates, or rely on individual transport instructions. The trip planning circuit can determine the merge point with the closest merge, the easiest merge, the most reliable transportation, to reduce overall trip time, to consider real-time user data, etc. Merge opportunities can be identified as shared geographical locations, or possibly overlapping candidate travel paths.

In addition, the trip planning circuit, given certain variables, such as available user transportation methods, memberships, costs, etc., determine optimal aspects of other variables. For example, a group of friends can provide a request for dinner on a specific evening. The trip planning circuit can evaluate user preferences, history, cost of transportation, or one or more other factors for the multiple users to determine a restaurant for dinner, for example, further taking into account reviews, etc. If a user exits from the planning, the trip planning circuit can update recommendations given the new set of users. Similarly, the trop planning circuit can update merge points, directions, etc., depending on changing conditions.

In other examples, the trip planning circuit can coordinate serendipitous shared trip segments between users otherwise going about their daily life. For example, if a first user is walking to the store while a second user is walking to the library at an overlapping time, the trip planning circuit can suggest that the users merge their separate routes, and provide an indication of the cost of such merger (e.g., extend trip by 3 minutes and 100 meters, but spend 10 minutes with your friend, Second User, etc.).

If a first user is jogging and a second user is walking nearby, and both users share permissions for each other, the trip planning circuit can suggest to one or both users that they merge their routes and, if approved, provide directions do to so. In certain examples, suggestions can be made according to user selections and permissions, such that coordination will not be suggested by certain users, or that certain users can be passively ignored or actively avoided. For example, the trip planning circuit can provide directions such that coordinated travel or accidental meetings do not occur with specific users.

The trip planning circuits and methods disclosed herein can provide the following advantages, among others; collective or collaborative trip planning; mixed multimodal operators, such as combinations of public transport, private operators, and private transport; intermittent or discontinuous usage (e.g., you can choose to pause, turn off, ignore, or not be seen, etc.); automated booking of ride-hailing and micro-mobility services agnostic to the user; trip suggestions based on trip-cost vs. trip-duration vs. wellbeing (e.g., user health, carbon footprint, etc.); user has a choice of options depending on circumstance (e.g., weather, emergency, time of day); wellbeing scores, such as reflecting health benefits, carbon footprint, etc.

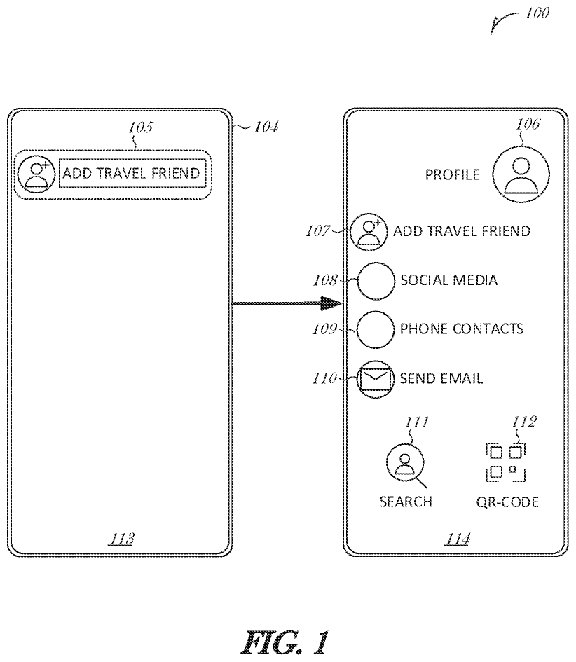

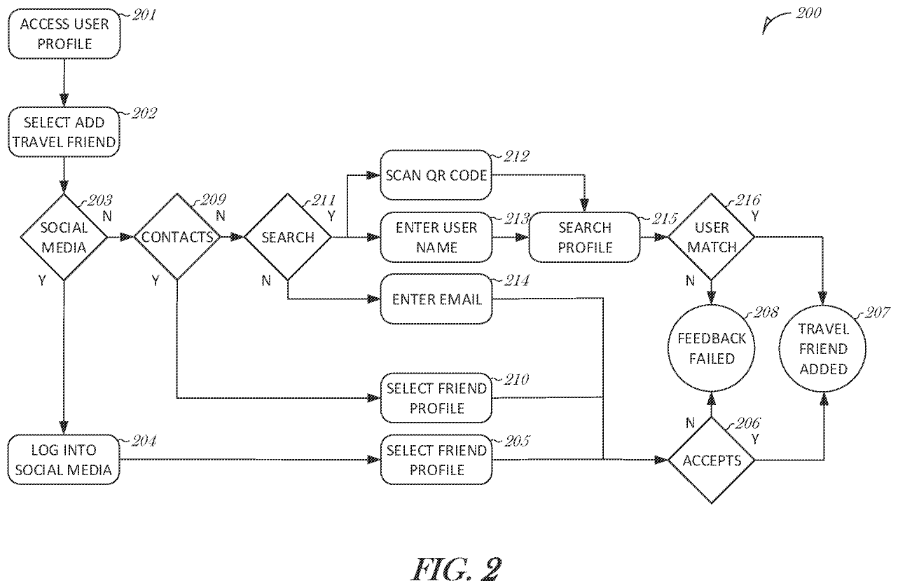

FIGS. 1 and 2 illustrate an example mobility system 100 and a method 200 of adding travel friends to a user profile to connect users of the mobility application. The mobility system 100 comprises first and second application views 113, 114 of the mobility application on a mobile device 104.

The first application view 113 includes an add travel friend element 105. In an example, when the add travel friend element 105 is selected, such as using a touch input, voice command, etc., the mobility application can transition to the second application view 114 having additional elements that enable a user to search for and add travel friends to coordinate meetings, rides, schedules, travel, exercise, or share travel time or experiences.

The second application view 114 includes a user profile element 106 associated with the user of the mobility application. The second application view 114 further comprises an add travel friend element 107, a social medial element 108, a phone contacts element 109, a send email element 110, a search element 111, and a QR-code element 112. The mobility application can be configured to receive user input, store various information of or from the user (e.g., preferences, previous trips, payment information, permissions, links to external devices, social media accounts, financial accounts, etc.), and provide routing, meeting, activity, or other information with the user.

The method 20 of adding travel friends to a user profile to connect users of the mobility application includes, at operation 201, accessing a user profile of the mobility application. The user profile can include a MaaS user profile of a mobility service application on a mobile device, such as the user profile element 106 of FIG. 1.

At operation 202, an add travel friend element can be selected. A travel friend can be added to the mobility application to receive data and permissions to coordinate travel, meeting place, event, exercise, etc. Travel friends can be added in a number of ways.

At operation 203, a travel friend can be added through a social media network, such as a social media profile or account. At operation 204, the user can log into, create, or otherwise link or access contacts of a social media account of the user. At operation 205, a profile of a social media friend or contact of the user can be selected from the social media account and a travel friend request can be sent to the social media friend, such as through the social media platform.

At operation 209, a travel friend can be added through contacts, such as contacts of the mobile device implementing the mobility application, etc. At operation 210, a profile a contact of the user can be selected, and a travel friend request can be provided to the contact, such as using messaging or other communication of the mobile device. At operation 214, a travel friend request can be provided to an email address. At operation 206, if the travel friend request from the user is accepted, the travel friend is added to the user profile at operation 207 as a connection to the user. If, at operation 206, the travel friend request is not accepted, such as affirmatively or passively denied, including unanswered after a period of time, the user can be provided feedback that the travel friend request has failed at operation 208.

At operation 211, a travel friend can be added through a search. At operation 212, the user can send, scan, or receive a QR code having identifiable information about either the user or the travel friend. At operation 213, a name, username, or other identifier of the travel friend can be added. At operation 215, profiles accessible to the mobile application, including information about users of the mobile application, can be searched to determine if the requested travel friend already exists in the system.

At operation 216, if the travel friend is matched in the profiles already accessible to the mobile application, then the travel friend is added to the user profile at operation 207 as a connection to the user. If, at operation 206, the travel friend request is not accepted, the user can be provided feedback that the travel friend request has failed at operation 208.

Once one or more travel friends are added to the user profile, the mobility application can access certain data of the user and the one or more travel friends (collectively. “users”), such as location, calendar, account, travel history, and travel preference information, etc., according to various controllable and revocable permissions. For example, users can limit, control, or hide their activity, availability, presence, or location with respect to the mobility application or specific users.

The mobility application can use data from users to coordinate interactions therebetween. Interactions can include, for example, collective trip planning given different locations and schedules, plan events or meet-ups between the users, including making location and transit recommendations given histories, capabilities, funds, preferences, etc., of the users.

Additional features include determination and display of carbon credits for choosing environmentally friendly transportation modes and can be deposited into a wallet. Redeeming of accrued carbon credits can also be done through the wallet. Wellbeing scores can be determined with respect to individual routes or segments and displayed to encourage healthy modes of transportation where available with incentives undertaking mass-transit, biking and such transportation methods. Mixed multimodal use of public, private, and personal transport can provide a great amount of flexibility for collaborative situational trip planning.

The mobility application can also store additional user information locally and securely on a variety of items, including: (1) preferred meeting points during collective trip planning; (2) locations for parking or storing user private transport (e.g., bicycle lockers or racks, parking lots, etc.); (3) preferred means of transportation from originating location based on day of the week, time of day, weather, etc.; and (4) preferred destinations, such as preferred grocery stores, restaurants, etc.

Additional features of collaborative multimodal trip planning can be modeled after online gaming platform (e.g., Play Station Network, Steam, etc.). In those models, one can invite a friend that is online to join an already existing game (in this case, a trip the user currently undertaking), or join a new game (e.g., ask a friend if they want to meet the initiating person at a destination, or during the progress of the trip). Some online gaming platforms also have the ability to send a message to an offline player, prompting them to go online and join the game. In our case of collaborative trip planning, a similar approach would be used to send an offline notification to the intended user informing them about a meet up (at a certain time for the movies or in the park) and asking if they would like to join.

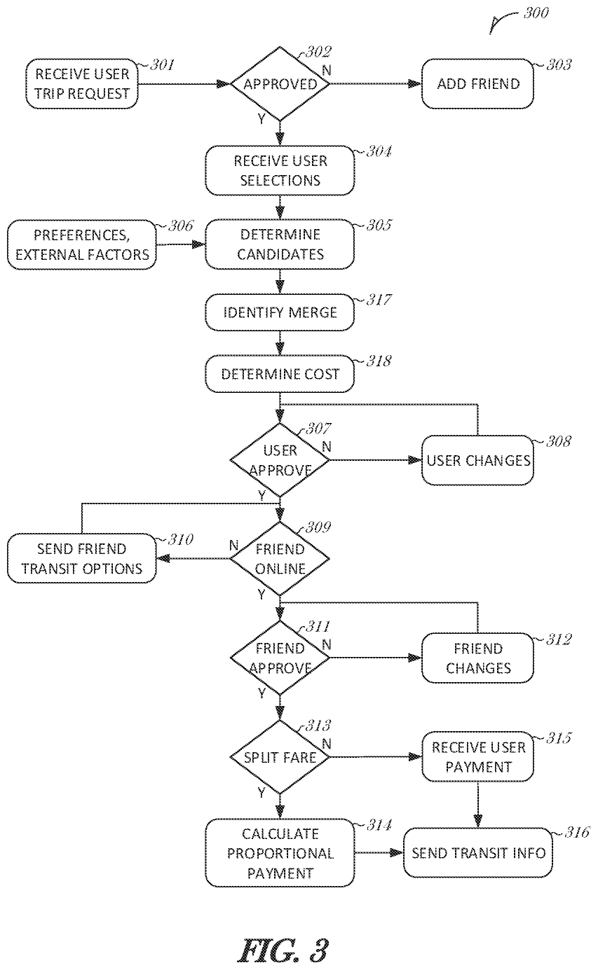

FIG. 3 illustrates an example collaborative trip planning method 300. At operation 301, a user trip request can be received, such as through a mobility application on a mobile device of the user, a web-enabled mobility application, etc. The user can identify a friend, such as using the mobility application or through the trip request, that the user desires to meet or travel with. At operation 302, if the friend is not approved, such as if the friend is not a user of the mobile application or has not agreed to share information with the mobile application or coordinate travel with the user, the friend can be added or invited for approval at operation 303, such as discussed in the method 200 of FIG. 2.

At operation 302, if the friend is approved, user selections for the user trip request can be received at operation 304. User selections can include, among other things, methods or means of travel, starting positions, destinations, waypoints, etc. At operation 305, candidate travel paths can be determined for the first and second users using location information of the respective user and the common meeting point, such as using a trip planning circuit as described herein, or otherwise determined using one or more processors, etc. At operation 306, information about the user, such as preferences or external factors, can be received. Information, such as preferences and external factors, etc., can including information of or from the user accessible by the mobility application. For example, preferences and external factors can include a personal vehicle type, the number of available passenger seats and safety belts in the personal vehicle (such as to possibly offer rides to friends, etc.), a preference for different travel modes, weather preferences (e.g., a desire for bicycle travel when not raining, covered travel while raining or outside a specific temperature range, etc.

At operation 317, merge opportunities in the candidate travel paths can be identified to coordinate shared travel between the first and second users. At operation 318 a cost of an adjusted travel paths can be determined using the identified merge opportunity from the candidate travel paths.

At operation 307, if the transit options are not approved by the user, one or more changes can be made at operation 308, such as additional criteria, different times or days, different modes of transportation, different destinations, merge point, or convergence, etc. If the transit options are approved by the user at operation 307, and the friend is determined as not online at operation 309, the determined transit options can be sent to the friend at operation 310, such as via email or through the mobility application.

At operation 311, if the transit options are not approved by the friend, one or more changes can be made at operation 312, such as additional criteria, different times or days, different modes of transportation, different destinations, waypoints, transit preferences, merge point, or convergence, etc. If the transit options are approved by the friend at operation 311, the cost of transit can be determined. At operation 313, the mobility application can determine whether or not the cost of transit, the fare, will be split. In an example, both users can be prompted with inquiries, such as using the mobility application. If both indicate, either via input or preferences, that they are amenable to split the fare, the fare can be split. If one user requests to pay the entire fare, a prompt can be presented to the other for approval. At operation 313, if the fare will not be split, user payment can be received at operation 315. At operation 313, if the fare will be split, proportional payment can be calculated at operation 314. At operation 316, transit information can be sent to the user and the friend.

In certain examples, the mobility application can have a link to a mobile wallet, banking institution or application, or stored funds. In certain examples, when the destination is a restaurant or an event requiring admission or participation cost, the determination to split fare at operation 313 can further apply to the restaurant or event as well. In other examples, the users can be prompted for both.

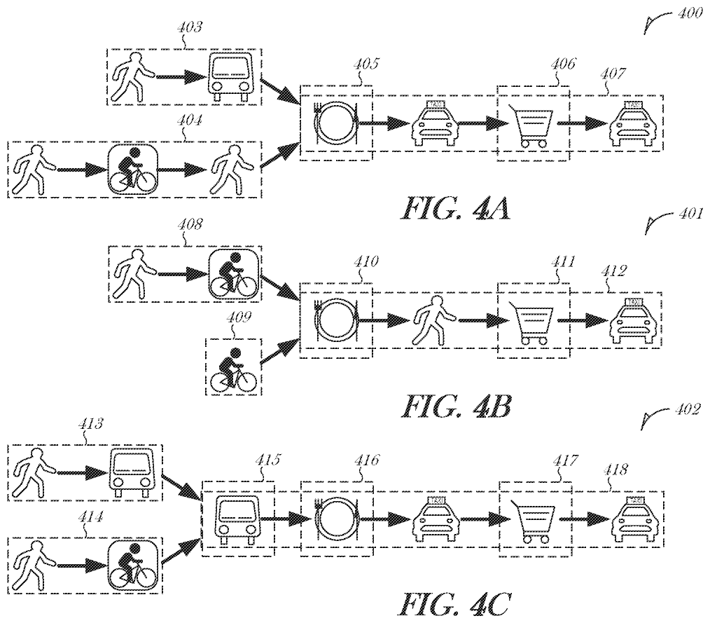

FIGS. 4A-4C illustrate example trip planning scenarios, including first, second, and third scenarios 400-402 of first and second users (or groups of users) collectively planning a trip, such as a multi-user transit plan. The example trip planning scenarios represent different trip options (e.g., candidate travel paths) for the same groups of people, with similar starting points for each group and the same event or meeting spot, but different trip options therebetween. In the examples of FIGS. 4A-4C, the final destinations of each user are the same, such as home (not shown) after the last trip segment. In other examples, events or waypoints can be considered destinations, with new trip planning starting when resuming travel, such as to home.

The first scenario 400 represents first and second users 403, 404 (or groups) collectively planning a trip that merges into a merged group 407 at a meeting point, in this example, an event 405 (e.g., a restaurant). The first and second users 403, 404 can start their respective trips at different locations (e.g., work and school, home and work, etc.). After the meeting point, the merged group 407 travels together for the remainder of the trip, including through the event 405 and a stopover 406 (e.g., an errand, such as a stop at a grocery store, etc.) before concluding the trip at a destination (e.g., home).

The second scenario 401 represents first and second users 408, 409 (or groups) collectively planning a trip that merges into a merged group 412 at a meeting point, in this example, an event 410 (e.g., a restaurant), and includes a stopover 411 (e.g., a grocery store). The event 410 and stopover 411 of the second scenario 402 can be the same as or different than the event 405 and stopover 406 of the first scenario 400, such that the first scenario 400 can differ from the second scenario 401 by the methods of travel of the first and second users (or groups) of the respective scenarios. In other examples, the meeting points, events, stopover points, and methods of travel of the merged groups can differ/vary.

The third scenario 402 represents first and second users 413, 414 (or groups) collectively planning a trip that merges into a merged group 418 at a meeting point 415 (e.g., a shared bus segment), and includes an event 416 (e.g., a restaurant) and a stopover 417 (e.g., a grocery store). In contrast to the first and second scenarios 400, 401, the third scenario 402 illustrates first and second users 413, 414 merging for a trip segment, such as a last bus segment before the restaurant instead of meeting at the restaurant. In certain examples, the overall transit time of one or both of the first and second users 413, 414 can increase, but the shared time between first and second users 413, 414 for the overall scenario also increases, and waiting time associated with the shared segments can be together, instead of separately. The mobile application can make recommendations, such as if the increase in shared time is more than the increase in transit time.

The mobile application can provide a distinct user experience of planning the trip collaboratively. For example, the wait time for each scenario and options therewithin, such as start time, duration, origins or starting locations, etc., can be illustrated with respect to each segment, as well as selectable or searchable options for the time and location of the events, meeting points, or stopovers. Each adjustment can dynamically show the impact to the trip, and different scenarios can be contrasted. User choices and selections can be shown to or hidden from others.

Table 1 illustrates example aggregate display elements associated with the different trip scenarios. In other examples, individual users can be displayed information specific to their segments, such as route details, start time, navigation instructions, etc. Assuming an event time of 90 minutes, a stopover time of 20 minutes, taxi rides of 5 minutes, and a post-event walking segment of 15 minutes, provides the following example values:

TABLE 1
Transit information

| | | | Transit | | | |
|---|---|---|---|---|---|---|
| | | | duration | | | |
| | | | pre/post | Waiting | Shared | |
| | Start | Time of | event | time | time | End |
| Scenario | time | merge/event | (mins) | (mins) | (mins) | time |
| First | 17:55 | 18:20 | 20/30 | 5 | 120 | 20:20 |
| Second | 17:55 | 18:20 | 25/40 | 0 | 130 | 20:30 |
| Third | 17:50 | 18:00/18:20 | 25/30 | 5 | 135 | 20:30 |

Transit duration, waiting time, and shared time can include times of individual modes or segments, aggregate for the collaborative users, or broken individually for each user of the scenario. As the pre-event durations for the different users can be different, the start times in Table 1, of which the end time is based, can include the time of one of the users, such as the earliest start time, etc. In other examples, the individual values can be broken further into differences of the individual users.

Small changes in travel can make larger impacts in time spent together by users. For example, the first and third scenarios differ mainly in the second user joining the first user for the last segment of travel to the event. However, the additional time together during transit (e.g., 10 minutes) is further amplified by waiting time that, instead of being spent by one user waiting for the other, can be spent together. When one user must wait for the other to join the segment, the waiting time can be offset by the following shared transit time, or offset by the fact that much of that wait time would have had to occur at the event or meeting point anyway.

Additionally, user wellbeing and environment impact can be factored into multimodal trip planning. Health scores associated with the methods of travel, carbon credits associated with environmentally conscious transit choices, and other information for each scenario or options can be determined, displayed, and used to order travel options.

In certain examples, wellbeing scores can be relative to other scenarios, and can include scores determined according to physical wellbeing associated with the selected modes of travel, mental wellbeing associated with time spent with other members of the trip, or combinations of both with respect to various weightings or variables, adjustable by the user or with respect to individual preferences, etc. In certain examples, user input after the event, such as a simple score rating of the individual segments or the trip overall, can be received. The mobile application can determine relative weightings and preferences specific to the user. In other examples, group information can be used, such as based on population information, to make recommendations to the users. Carbon credits can be determined according to a carbon offset calculation for the aggregate trip or individually for each user of each scenario.

TABLE 1
Transit scores

| Scenario | Wellbeing (High/Med/Low) | Carbon credits |
|---|---|---|
| First | Med | −85 |
| Second | High | +30 |
| Third | Med | −85 |

In an example, multimodal transportation combinations can be presented to a user depending on, among other things, trip duration, physical or mental wellbeing indications, carbon credit calculations, additional cost to the user, weather alerts, etc. With inputs from the user on their preferences for the mode of transport based on the situation, certain options can be added/eliminated from the suggestions.

Aggregate indications of physical and mental wellbeing, as well as carbon credits for travel segments, can be tracked and displayed to the user in various ways. For example, a plant can be displayed with more or less foliage depending on the aggregate or past several days or instances of selected multimodal transportation selections. In other examples, other symbolic displays can be made or determined. In certain examples, wellbeing information can be presented, such as to an insurance provider or other company or party concerned with the wellbeing of the user. Similarly, carbon credits can be aggregated and associated with a financial incentive or score to incentivize less impactful transportation selections.

User profiles can be created based on user input or through interaction with the user. In various situations, different options can be preferred. For example, in an emergency, options can be sorted and prioritized based on duration. Under normal usage, options can be sorted and prioritized based on one of indications of wellbeing, carbon credits, cost, etc. Additional levels of sorting and prioritization can include weather indications (e.g., minimize bike and walking travel if rain is forecast, etc.), day or time of the requested transportation (e.g., weekday commute versus weekend leisure, etc.). A universal transport wallet can additionally be created and carried out using the mobile application, such as in concert with one or more financial applications, services, or institutions, to simplify ticket purchase, increase the likelihood of payment, etc.

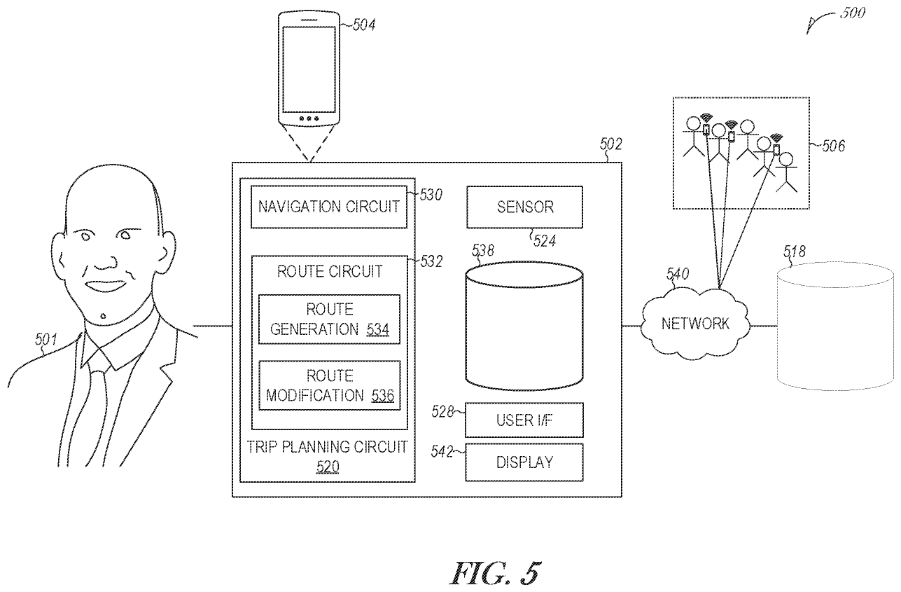

FIG. 5 illustrates an example processing platform 502, such as of a mobile device 504 of a user 501, the processing platform 502 including a trip planning circuit 520 and associated components and subcomponents, including a user interface 528 configured to receive information from the user 501 (or other users, such as friends, family members, or connected users, such as through a mobile application, etc.), a navigation circuit 530 configured to, among other things, determine at least one candidate travel path for a user, provide navigation guidance to a user, a route circuit 532 comprising a route generation circuit 534 and a route modification circuit 536 configured to determine candidate routes and alter such based on input from or preferences of a user or groups of users, and a display 542 configured to provide information to the user 501.

In an example, the processing platform 502 can determine a location, speed, and average speed of the user 501 or otherwise receive inertial, accelerometer, or location information, such as from a sensor 524, etc. Information about navigation, routes, the user 501, etc., can be stored in a database 538. Information, such as routing information or options can be provided to the user 501 using a display 542. The processing platform 502 can further be coupled to a database 518 external to the processing platform 502 or the mobile device 504, such as through a network 540, configured to store or contain different information from one or more other users geographic mapping information, etc.

In an example, one or more other users 506 can be coupled to the network 540. Information or communication from the one or more other users 506 can be used to determine a multi-user transit plan.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the—readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

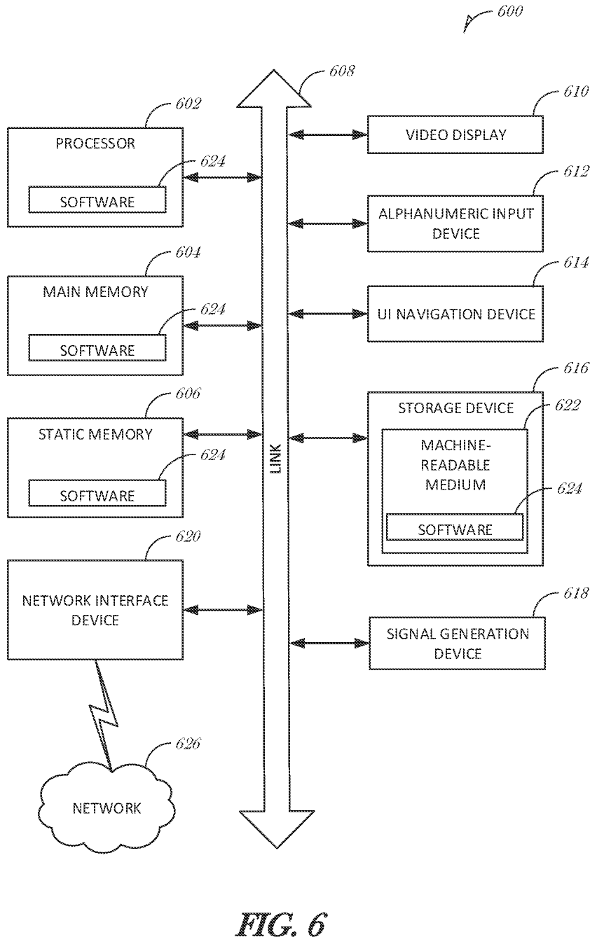

FIG. 6 illustrates an example machine in the form of a computer system 600, within which a set or sequence of instructions may be executed to cause the machine to perform any one of the methodologies discussed herein. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem, a personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, gyrometer, magnetometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include nonvolatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, LoRa/LoRaWAN, or satellite communication networks). The term “transmission medium” shall be taken to include any intangible medium that is capable of storing, encoding, or carrying instructions for execution by the machine, and includes digital or analog communications signals or other intangible medium to facilitate communication of such software.

Example 1 is a system comprising: a trip planning circuit configured to receive a user request for a multi-user transit plan to route first and second users to a common meeting point, the first and second users having different starting locations and to receive location information for each of the first and second users; and a navigation circuit configured to determine candidate travel paths for the first and second users using the location information for the respective user and the common meeting point; wherein the trip planning circuit is configured to: identify a merge opportunity in the candidate travel paths to coordinate shared travel between the first and second users; determine a cost of adjusted travel paths for the first and second users using the identified merge opportunity with respect to the candidate travel paths; and communicate the adjusted travel paths to the first and second users.

In Example 2, the subject matter of Example 1 includes, wherein the navigation circuit is configured to determine estimated travel times of the candidate travel paths for the first and second users, wherein the trip planning circuit is configured to determine estimated travel times of the adjusted travel paths for the first and second users, and wherein to determine the cost of the adjusted travel paths with respect to the candidate travel paths, the trip planning circuit is configured to: determine a difference between the estimated travel times of the candidate travel paths and the estimated travel times of the adjusted travel paths.

In Example 3, the subject matter of Example 2 includes, wherein to determine the difference between the estimated travel times of the candidate travel paths and the estimated travel times of the adjusted travel paths, the trip planning circuit is configured to: subtract the estimated travel times of the candidate travel paths from the estimated travel times of the adjusted travel paths to determine an aggregate time cost, and wherein the trip planning circuit is configured to determine the multi-user transit plan as the adjusted travel paths if the aggregate time cost is less than a threshold.

In Example 4, the subject matter of Examples 1-3 includes, wherein the trip planning circuit is configured to provide an indication of the cost of the adjusted travel paths with respect to the candidate travel paths to at least one of the first or second users, and wherein the trip planning circuit is configured to receive a selection of the candidate travel paths or the adjusted travel paths in response to the provided indication.

In Example 5, the subject matter of Example 4 includes, a user interface configured to: provide the cost of the adjusted travel paths with respect to the candidate travel paths to at least one of the first and second users, and in response to the provided cost, receive a selection of the candidate travel paths or the adjusted travel paths.

In Example 6, the subject matter of Examples 1-5 includes, wherein the trip planning circuit is configured to determine the transit plan for the first and second users based on the cost of the adjusted travel paths with respect to the candidate travel paths.

In Example 7, the subject matter of Examples 1-6 includes, wherein the trip planning circuit is configured to: determine an estimated shared travel time for the first and second users of the adjusted travel paths between the merge opportunity and the common meeting point; and determine the multi-user transit plan as the adjusted travel paths if the cost of the adjusted travel paths is less than the estimated shared travel time for the first and second users of the adjusted travel paths, wherein the cost of the adjusted travel paths is a measure of time.

In Example 8, the subject matter of Examples 1-7 includes, wherein the navigation circuit is configured to receive user travel preferences of the first and second users and to determine candidate travel paths for the first and second users using the location information for the respective user, the common meeting point, and the user travel preferences, wherein the candidate travel paths comprise combinations of different travel modalities, the travel modalities comprising at least one mobility-as-a-service (MaaS) or public transit vehicle, wherein the user request comprises a request for the multi-user transit plan from the first user, the request for the multi-user transit comprising at least one of a proposed time of departure for at least one of the users of the multi-user transit plan or a proposed time of meeting at the common meeting point, wherein the user request comprises a proposed departure location of at least one of the first or second users, and wherein to determine the candidate travel paths, the navigation circuit is configured to determine optimal candidate travel paths for the first and second users based on the received user travel preferences.

In Example 9, the subject matter of Examples 1-8 includes, wherein the trip planning circuit is configured to: determine indications of wellbeing for the candidate travel paths and the adjusted travel paths for the first and second users; and determine indications of environmental impact for the candidate travel paths and the adjusted travel paths for the first and second users, and wherein the system comprises a user interface configured to: provide the indications of wellbeing and environmental impact for the candidate travel paths and the adjusted travel paths for the first and second users to one of the first and second users; and in response to the provided indications of wellbeing and environmental impact, receive a selection of the candidate travel paths or the adjusted travel paths.

Example 10 is a method comprising: receiving a user request for a multi-user transit plan to route first and second users to a common meeting point, the first and second users having different starting locations; receiving location information for each of the first and second users; determining candidate travel paths for the first and second users using the location information for the respective user and the common meeting point; identifying a merge opportunity in the candidate travel paths to coordinate shared travel between the first and second users; determining a cost of adjusted travel paths for the first and second users using the identified merge opportunity with respect to the candidate travel paths; and communicating the adjusted travel paths to the first and second users.

In Example 11, the subject matter of Example 10 includes, determining estimated travel times of the candidate travel paths for the first and second users; and determining estimated travel times of the adjusted travel paths for the first and second users, wherein determining the cost of the adjusted travel paths with respect to the candidate travel paths comprises determining a difference between the estimated travel times of the candidate travel paths and the estimated travel times of the adjusted travel paths.

In Example 12, the subject matter of Example 11 includes, wherein determining the difference between the estimated travel times of the candidate travel paths and the estimated travel times of the adjusted travel paths comprises subtracting the estimated travel times of the candidate travel paths from the estimated travel times of the adjusted travel paths to determine an aggregate time cost, and wherein the method includes determining the multi-user transit plan using the aggregate time cost.

In Example 13, the subject matter of Examples 10-12 includes, providing an indication of the cost of the adjusted travel paths with respect to the candidate travel paths to at least one of the first or second users; and receiving, in response to the provided indication, a selection of the candidate travel paths or the adjusted travel paths.

In Example 14, the subject matter of Examples 10-13 includes, determining an estimated shared travel time for the first and second users of the adjusted travel paths between the merge opportunity and the common meeting point; and determining the multi-user transit plan as the adjusted travel paths if the cost of the adjusted travel paths is less than the estimated shared travel time for the first and second users of the adjusted travel paths, wherein the cost of the adjusted travel paths is a measure of time.

In Example 15, the subject matter of Examples 10-14 includes, receiving user travel preferences of the first and second users; and determining candidate travel paths for the first and second users using the location information for the respective user, the common meeting point, and the user travel preferences, wherein the candidate travel paths comprise combinations of different travel modalities, the travel modalities comprising at least one mobility-as-a-service (MaaS) or public transit vehicle, wherein the user request comprises a request for the multi-user transit plan from the first user, the request for the multi-user transit comprising at least one of a proposed time of departure for at least one of the users of the multi-user transit plan or a proposed time of meeting at the common meeting point, and wherein determining the candidate travel paths comprises determining optimal candidate travel paths for the first and second users based on the received user travel preferences.

In Example 16, the subject matter of Examples 10-15 includes, determining indications of wellbeing for the candidate travel paths and the adjusted travel paths for the first and second users; determining indications of environmental impact for the candidate travel paths and the adjusted travel paths for the first and second users; and providing the indications of wellbeing and environmental impact for the candidate travel paths and the adjusted travel paths for the first and second users to one of the first and second users; and receiving, in response to the provided indications of wellbeing and environmental impact, a selection of the candidate travel paths or the adjusted travel paths.

Example 17 is at least one non-transitory machine-readable medium including instructions that, when executed by hardware circuitry, cause the hardware circuitry to perform operations comprising: receiving a user request for a multi-user transit plan to route first and second users to a common meeting point, the first and second users having different starting locations receiving location information for each of the first and second users; determining candidate travel paths for the first and second users using the location information for the respective user and the common meeting point; identifying a merge opportunity in the candidate travel paths to coordinate shared travel between the first and second users; determining a cost of adjusted travel paths for the first and second users using the identified merge opportunity with respect to the candidate travel paths; and communicating the adjusted travel paths to the first and second users.

In Example 18, the subject matter of Example 17 includes, the operations comprising: determining estimated travel times of the candidate travel paths for the first and second users and determining estimated travel times of the adjusted travel paths for the first and second users, wherein determining the cost of the adjusted travel paths with respect to the candidate travel paths comprises determining a difference between the estimated travel times of the candidate travel paths and the estimated travel times of the adjusted travel paths.

In Example 19, the subject matter of Example 18 includes, wherein determining the difference between the estimated travel times of the candidate travel paths and the estimated travel times of the adjusted travel paths comprises subtracting the estimated travel times of the candidate travel paths from the estimated travel times of the adjusted travel paths to determine an aggregate time cost, and wherein the operations include determining the multi-user transit plan using the aggregate time cost.

In Example 20, the subject matter of Examples 17-19 includes, the operations comprising: providing an indication of the cost of the adjusted travel paths with respect to the candidate travel paths to at least one of the first or second users; and receiving, in response to the provided indication, a selection of the candidate travel paths or the adjusted travel paths.

In Example 21, the subject matter of Examples 17-20 includes, the operations comprising: determining an estimated shared travel time for the first and second users of the adjusted travel paths between the merge opportunity and the common meeting point; and determining the multi-user transit plan as the adjusted travel paths if the cost of the adjusted travel paths is less than the estimated shared travel time for the first and second users of the adjusted travel paths, wherein the cost of the adjusted travel paths is a measure of time.

In Example 22, the subject matter of Examples 17-21 includes, the operations comprising: receiving user travel preferences of the first and second users, and determining candidate travel paths for the first and second users using the location information for the respective user, the common meeting point, and the user travel preferences, wherein the candidate travel paths comprise combinations of different travel modalities, the travel modalities comprising at least one mobility-as-a-service (MaaS) or public transit vehicle, wherein the user request comprises a request for the multi-user transit plan from the first user, the request for the multi-user transit comprising at least one of a proposed time of departure for at least one of the users of the multi-user transit plan or a proposed time of meeting at the common meeting point, and wherein determining the candidate travel paths comprises determining optimal candidate travel paths for the first and second users based on the received user travel preferences.

In Example 23, the subject matter of Examples 17-22 includes, the operations comprising: determining indications of wellbeing for the candidate travel paths and the adjusted travel paths for the first and second users; determining indications of environmental impact for the candidate travel paths and the adjusted travel paths for the first and second users; and providing the indications of wellbeing and environmental impact for the candidate travel paths and the adjusted travel paths for the first and second users to one of the first and second users; and receiving, in response to the provided indications of wellbeing and environmental impact, a selection of the candidate travel paths or the adjusted travel paths.

Example 24 is a system comprising: means for receiving a user request for a multi-user transit plan to route first and second users to a common meeting point from different starting locations; means for receiving location information of the first and second users; means for determining candidate travel paths for the first and second users using the location information of the respective user and the common meeting point; means for identifying a merge opportunity in the candidate travel paths to coordinate shared travel between the first and second users; means for determining adjusted travel paths and a cost of the adjusted travel paths for the first and second users using the identified merge opportunity from the candidate travel paths; and means for communicating the adjusted travel paths to the first and second users.

In Example 25, the subject matter of Example 24 includes, means for determining estimated travel times of the candidate travel paths for the first and second users; and means for determining estimated travel times of the adjusted travel paths for the first and second users, wherein means for determining the cost of the adjusted travel paths with respect to the candidate travel paths comprises means for determining a difference between the estimated travel times of the candidate travel paths and the estimated travel times of the adjusted travel paths.

In Example 26, the subject matter of Example 25 includes, wherein means for determining the difference between the estimated travel times of the candidate travel paths and the estimated travel times of the adjusted travel paths comprises means for subtracting the estimated travel times of the candidate travel paths from the estimated travel times of the adjusted travel paths to determine an aggregate time cost, and wherein the system includes means for determining the multi-user transit plan using the aggregate time cost.

In Example 27, the subject matter of Examples 24-26 includes, means for providing the cost of the adjusted travel paths with respect to the candidate travel paths to at least one of the first or second users; and means for receiving, in response to the provided cost, a selection of the candidate travel paths or the adjusted travel paths.

In Example 28, the subject matter of Examples 24-27 includes, means for determining an estimated shared travel time for the first and second users of the adjusted travel paths between the merge opportunity and the common meeting point; and means for determining the multi-user transit plan as the adjusted travel paths if the cost of the adjusted travel paths is less than the estimated shared travel time for the first and second users of the adjusted travel paths, wherein the cost of the adjusted travel paths is a measure of time.

In Example 29, the subject matter of Examples 24-28 includes, means for receiving user travel preferences of the first and second users; and means for determining candidate travel paths for the first and second users using the location information for the respective user, the common meeting point, and the user travel preferences, wherein the candidate travel paths comprise combinations of different travel modalities, the travel modalities comprising at least one mobility-as-a-service (MaaS) or public transit vehicle, wherein the user request comprises a request for the multi-user transit plan from the first user, the request for the multi-user transit comprising at least one of a proposed time of departure for at least one of the first or second users of the multi-user transit plan or a proposed time of meeting at the common meeting point, and wherein means for determining the candidate travel paths comprises means for determining optimal candidate travel paths for the first and second users based on the received user travel preferences.

In Example 30, the subject matter of Examples 24-29 includes, means for determining indications of wellbeing for the candidate travel paths and the adjusted travel paths for the first and second users; means for determining indications of environmental impact for the candidate travel paths and the adjusted travel paths for the first and second users; and means for providing the indications of wellbeing and environmental impact for the candidate travel paths and the adjusted travel paths for the first and second users to one of the first and second users; and means for receiving, in response to the provided indications of wellbeing and environmental impact, a selection of the candidate travel paths or the adjusted travel paths.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system comprising:
a trip planning circuit configured to receive a user request for a multi-user transit plan to route first and second users to a common meeting point from, different starting locations, and to receive location information of the first and second users; and
a navigation circuit configured to determine candidate travel paths for the first and second users using the location information of the respective user and the common meeting point;
wherein the trip planning circuit is configured to:
identify a merge opportunity in the candidate travel paths to coordinate shared travel between the first and second users;
determine adjusted travel paths for the first and second users and a cost of the adjusted travel paths using the identified merge opportunity from the candidate travel paths; and
communicate the adjusted travel paths to the first and second users.

2. The system of claim 1, wherein the navigation circuit is configured to determine estimated travel times of the candidate travel paths for the first and second users,
wherein the trip planning circuit is configured to determine estimated travel times of the adjusted travel paths for the first and second users, and
wherein to determine the cost of the adjusted travel paths with respect to the candidate travel paths, the trip planning circuit is configured to:
determine a difference between the estimated travel times of the candidate travel paths and the estimated travel times of the adjusted travel paths.

3. The system of claim 2, wherein to determine the difference between the estimated travel times of the candidate travel paths and the estimated travel times of the adjusted travel paths, the trip planning circuit is configured to:
subtract the estimated travel times of the candidate travel paths from the estimated travel times of the adjusted travel paths to determine an aggregate time cost, and
wherein the trip planning circuit is configured to determine the multi-user transit plan as the adjusted travel paths if the aggregate time cost is less than a threshold.

4. The system of claim 1, wherein the trip planning circuit is configured to provide the cost of the adjusted travel paths with respect to the candidate travel paths to at least one of the first or second users, and
wherein the trip planning circuit is configured to receive a selection of the candidate travel paths or the adjusted travel paths in response to the provided cost.

5. The system of claim 4, comprising a user interface configured to:
provide the cost of the adjusted travel paths with respect to the candidate travel paths to at least one of the first and second users; and
in response to the provided cost, receive a selection of the candidate travel paths or the adjusted travel paths.

6. The system of claim 1, wherein the trip planning circuit is configured to determine the transit plan for the first and second users based on the cost of the adjusted travel paths with respect to the candidate travel paths.

7. The system of claim 1, wherein the trip planning circuit is configured to:
determine an estimated shared travel time for the first and second users of the adjusted travel paths between the merge opportunity and the common meeting point; and
determine the multi-user transit plan as the adjusted travel paths if the cost of the adjusted travel paths is less than the estimated shared travel time for the first and second users of the adjusted travel paths, wherein the cost of the adjusted travel paths is a measure of time.

8. The system of claim 1, wherein the navigation circuit is configured to receive user travel preferences of the first and second users and to determine candidate travel paths for the first and second users using the location information for the respective user, the common meeting point, and the user travel preferences,
wherein the candidate travel paths comprise combinations of different travel modalities, the travel modalities comprising at least one mobility-as-a-service (MaaS) or public transit vehicle,
wherein the user request comprises a request for the multi-user transit plan from the first user, the request for the multi-user transit comprising at least one of a proposed time of departure for at least one of the first or second users of the multi-user transit plan or a proposed time of meeting at the common meeting point,
wherein the user request comprises a proposed departure location of at least one of the first or second users, and
wherein to determine the candidate travel paths, the navigation circuit is configured to determine optimal candidate travel paths for the first and second users based on the received user travel preferences.

9. The system of claim 1, wherein the trip planning circuit is configured to:
determine indications of wellbeing for the candidate travel paths and the adjusted travel paths for the first and second users; and
determine indications of environmental impact for the candidate travel paths and the adjusted travel paths for the first and second users, and
wherein the system comprises a user interface configured to:
provide the indications of wellbeing and environmental impact for the candidate travel paths and the adjusted travel paths for the first and second users to one of the first and second users; and
in response to the provided indications of wellbeing and environmental impact, receive a selection of the candidate travel paths or the adjusted travel paths.

10. A system comprising:
means for receiving a user request for a multi-user transit plan to route first and second users to a common meeting point from different starting locations;
means for receiving location information of the first and second users;
means for determining candidate travel paths for the first and second users using the location information of the respective user and the common meeting point;
means for identifying a merge opportunity in the candidate travel paths to coordinate shared travel between the first and second users;
means for determining adjusted travel paths and a cost of the adjusted travel paths for the first and second users using the identified merge opportunity from the candidate travel paths; and
means for communicating the adjusted travel paths to the first and second users.

11. The system of claim 10, comprising:
means for determining estimated travel times of the candidate travel paths for the first and second users; and
means for determining estimated travel times of the adjusted travel paths for the first and second users,
wherein means for determining the cost of the adjusted travel paths with respect to the candidate travel paths comprises means for determining a difference between the estimated travel times of the candidate travel paths and the estimated travel times of the adjusted travel paths.

12. The system of claim 11, wherein means for determining the difference between the estimated travel times of the candidate travel paths and the estimated travel times of the adjusted travel paths comprises means for subtracting the estimated travel times of the candidate travel paths from the estimated travel times of the adjusted travel paths to determine an aggregate time cost, and
wherein the system includes means for determining the multi-user transit plan using the aggregate time cost.

13. The system of claim 10, comprising:
means for providing the cost of the adjusted travel paths with respect to the candidate travel paths to at least one of the first or second users; and
means for receiving, in response to the provided cost, a selection of the candidate travel paths or the adjusted travel paths.

14. The system of claim 10, comprising:
means for determining an estimated shared travel time for the first and second users of the adjusted travel paths between the merge opportunity and the common meeting point; and
means for determining the multi-user transit plan as the adjusted travel paths if the cost of the adjusted travel paths is less than the estimated shared travel time for the first and second users of the adjusted travel paths, wherein the cost of the adjusted travel paths is a measure of time.

15. The system of claim 10, comprising:
means for receiving user travel preferences of the first and second users; and
means for determining candidate travel paths for the first and second users using the location information for the respective user, the common meeting point, and the user travel preferences,
wherein the candidate travel paths comprise combinations of different travel modalities, the travel modalities comprising at least one mobility-as-a-service (MaaS) or public transit vehicle,
wherein the user request comprises a request for the multi-user transit plan from the first user, the request for the multi-user transit comprising at least one of a proposed time of departure for at least one of the first or second users of the multi-user transit plan or a proposed time of meeting at the common meeting point, and
wherein means for determining the candidate travel paths comprises means for determining optimal candidate travel paths for the first and second users based on the received user travel preferences.

16. The system of claim 10, comprising:
means for determining indications of wellbeing for the candidate travel paths and the adjusted travel paths for the first and second users;
means for determining indications of environmental impact for the candidate travel paths and the adjusted travel paths for the first and second users; and
means for providing the indications of wellbeing and environmental impact for the candidate travel paths and the adjusted travel paths for the first and second users to one of the first and second users; and
means for receiving, in response to the provided indications of wellbeing and environmental impact, a selection of the candidate travel paths or the adjusted travel paths.

17. At least one non-transitory machine-readable medium including instructions that, when executed by hardware circuitry, cause the hardware circuitry to perform operations comprising:
receiving a user request for a multi-user transit plan to route first and second users to a common meeting point from different starting locations;
receiving location information of the first and second users;
determining candidate travel paths for the first and second users using the location information of the respective user and the common meeting point;
identifying a merge opportunity in the candidate travel paths to coordinate shared travel between the first and second users;
determining adjusted travel paths and a cost of the adjusted travel paths for the first and second users using the identified merge opportunity from the candidate travel paths; and
communicating the adjusted travel paths to the first and second users.

18. The at least one machine-readable medium of claim 17, the operations comprising:
determining estimated travel times of the candidate travel paths for the first and second users; and
determining estimated travel times of the adjusted travel paths for the first and second users,
wherein determining the cost of the adjusted travel paths with respect to the candidate travel paths comprises determining a difference between the estimated travel times of the candidate travel paths and the estimated travel times of the adjusted travel paths.

19. The at least one machine-readable medium of claim 18, wherein determining the difference between the estimated travel times of the candidate travel paths and the estimated travel times of the adjusted travel paths comprises subtracting the estimated travel times of the candidate travel paths from the estimated travel times of the adjusted travel paths to determine an aggregate time cost, and
wherein the operations include determining the multi-user transit plan using the aggregate time cost.

20. The at least one machine-readable medium of claim 17, the operations comprising:
providing the cost of the adjusted travel paths with respect to the candidate travel paths to at least one of the first or second users; and
receiving, in response to the provided cost, a selection of the candidate travel paths or the adjusted travel paths.

21. The at least one machine-readable medium of claim 17, the operations comprising:
determining an estimated shared travel time for the first and second users of the adjusted travel paths between the merge opportunity and the common meeting point; and
determining the multi-user transit plan as the adjusted travel paths if the cost of the adjusted travel paths is less than the estimated shared travel time for the first and second users of the adjusted travel paths, wherein the cost of the adjusted travel paths is a measure of time.

22. The at least one machine-readable medium of claim 17, the operations comprising:
receiving user travel preferences of the first and second users; and
determining candidate travel paths for the first and second users using the location information for the respective user, the common meeting point, and the user travel preferences,
wherein the candidate travel paths comprise combinations of different travel modalities, the travel modalities comprising at least one mobility-as-a-service (MaaS) or public transit vehicle,
wherein the user request comprises a request for the multi-user transit plan from the first user, the request for the multi-user transit comprising at least one of a proposed time of departure for at least one of the first or second users of the multi-user transit plan or a proposed time of meeting at the common meeting point, and
wherein determining the candidate travel paths comprises determining optimal candidate travel paths for the first and second users based on the received user travel preferences.

23. The at least one machine-readable medium of claim 17, the operations comprising:
determining indications of wellbeing for the candidate travel paths and the adjusted travel paths for the first and second users;
determining indications of environmental impact for the candidate travel paths and the adjusted travel paths for the first and second users; and
providing the indications of wellbeing and environmental impact for the candidate travel paths and the adjusted travel paths for the first and second users to one of the first and second users; and
receiving, in response to the provided indications of wellbeing and environmental impact, a selection of the candidate travel paths or the adjusted travel paths.
